(19) United States
(12) Patent Application Publication
(10) Pub. No.: US 2004/0119052 A1
(43) Pub. Date: Jun. 24, 2004

(54) Process for preparing alpha- and beta- methyl-gamma-butyrolactone and 3-methyltetrahydrofuran

(76) Inventors: William Anthony Beavers, Longview, TX (US); Alexey Victorovitch Ignatchenko, Longview, TX (US)

Correspondence Address: Michael J. Blake, Eastman Chemical Company, P.O. Box 511, Kingsport, TN, 37662-5075, US

(21) Appl. No.: 10/324,961

(22) Filed: Dec. 20, 2002

(51) Int. Cl. B01F 3/12

(52) U.S. Cl. 252/364

(57) ABSTRACT

The present invention pertains to a novel process for preparing alpha- and beta-methyl-gamma-butyrolactones (MeGBL) and/or 3-Methyltetrahydrofuran (MeTHF) from 3-(hydroxymethyl)tetrahydrofuran (HOMeTHF), 3-formyltetrahydrofuran (FTHF) or a mixture thereof by contacting HOMeTHF, FTHF, or a mixture thereof with a catalyst comprising copper on hydrous zirconia under conditions of temperature and pressure conducive to the formation of MeGBL and/or MeTHF The process may be performed in the presence of an inert atmosphere and/or hydrogen gas. Further, the process may be performed in the presence of a secondary alcohol.

### FIELD OF THE INVENTION

The present invention pertains to a novel process for preparing alpha- and beta-methyl-gamma-butyrolactones (alpha-MeGBL, beta-MeGBL) and/or 3-Methyltetrahydrofuran (MeTHF).

### BACKGROUND OF THE INVENTION

Alpha-MeGBL is known to be useful as a solvent and as an intermediate in the manufacture of various materials such as, for example, polyurethanes. In addition, U.S. Pat. No. 5,532,271 discloses that alpha-MeGBL has immunosuppresant and anti-inflammatory activity and U.S. Pat. Nos. 4,665,091 and 4,851,436 disclose the use of alpha-MeGBL as a starting material for the synthesis of an antihypercholesterolemic compound. Zell, Helv. Chim Acta, (1979), 62(2), 474, discloses that (−)-S-alpha-MeGBL can be the central building block in the formation of the side chain of alpha-tocopherol.

JP 06-092,951 discloses the preparation of alpha-MeGBL by the hydroformylation of methyl methacrylate followed by reduction of the intermediate aldehyde to alpha-methyl-gamma-hydroxybutyrate. Jedlinski et al, J. Org. Chem., (1987) 52(2) 4601 disclose the synthesis of alpha-MeGBL via lactone enolates.

MeTHF produced in accordance with the present invention is useful as an industrial solvent and, more importantly, as a monomer in the manufacture of polymers such as elastomers. MeTHF is used extensively as a modifier for plasticizers giving modified glass transition temperatures and broader elastic ranges.

In addition, both alpha- and beta-methyl-gamma-butyrolactones, or a mixture thereof, may be catalytically reduced to produce MeTHF. See, for example U.S. Pat. No. 5,990,324, U.S. Pat. No. 4,006,104, and U.S. Pat. No. 3,969,371, discussing, inter alia, a reduction of unsubstituted gammabutyrolactone to tetrahydrofuran.

### BRIEF SUMMARY OF THE INVENTION

The present invention provides a process for producing alpha-MeGBL and beta-MeGBL (together, MeGBL), or its co-production with MeTHF, by contacting HOMeTHF, FTHF, or a mixture thereof, with a catalyst comprising copper deposited on hydrous zirconia. The process may be performed in the presence of an inert atmosphere, hydrogen gas or a mixture thereof. Further, the process is performed under conditions of temperature and pressure conducive to the formation of alpha-MeGBL and beta-MeGBL and/or MeTHF.

In addition, the invention provides a process in which alpha-MeGBL and beta-MeGBL and/or MeTHF are produced by contacting FTHF and/or HOMeTHF with a secondary alcohol in the presence of a catalyst comprising copper deposited on hydrous zirconia. This process may also be performed in the presence of an inert atmosphere, hydrogen gas or a mixture thereof.

### DETAILED DESCRIPTION OF THE INVENTION

The present invention provides a process for producing alpha-MeGBL and beta-MeGBL (together, MeGBL) or MeTHF, or co-production of alpha-MeGBL and beta-MeGBL (together, MeGBL) and MeTHF, by contacting HOMeTHF, FTHF, or a mixture thereof, with a catalyst comprising copper deposited on hydrous zirconia under conditions of temperature and pressure conducive to the formation of MeGBL and/or MeTHF. The process may be performed in the presence of an inert atmosphere or hydrogen gas or a mixture thereof.

In addition, the invention provides a process in which MeGBL and/or MeTHF are produced by contacting FTHF and/or HOMeTHF with a secondary alcohol in the presence of a catalyst comprising copper deposited on hydrous zirconia. This process may also be performed in the presence of an inert atmosphere or hydrogen gas or a mixture thereof.

The HOMeTHF or FTHF starting materials are commercially available, or may be made by processes known to those skilled in the art. See, for example, U.S. Pat. No. 5,840,928 to Satoh et al., which describes a method for making FTHF. Further, the HOMeTHF may be obtained, for example, by contacting FTHF with hydrogen in the presence of a hydrogenation catalyst to convert FTHF to HOMeTHF. See, e.g., co-pending U.S. application Ser. No. 10/125,664.

The hydrous zirconia used in our novel process may be any of a number of commercially available zirconia catalyst products, which are commonly used as support media for other metals or metal complexes. In the alternative, the hydrous zirconia for use in the present invention may be made by processes known to those of skill in the art.

For example, the hydrous zirconia may be prepared by treating a zirconium salt or other zirconium precursor compound with a base. Any of a number of zirconium salts may serve as starting materials for the catalyst preparation, although the preferred salts are soluble in water. Examples of zirconium precursor compounds, which may be used include zirconium chloride, zirconium bromide, zirconium iodide, zirconium fluoride, zirconyl chloride, zirconyl bromide, zirconyl iodide, zirconyl fluoride, zirconium nitrate, zirconium sulfate, zirconium bicarbonate, zirconium carbonate, zirconium hydroxide, hydrated zirconias, and zirconium containing organometallic or inorganic complexes. A preferred zirconium source is zirconyl chloride or zirconyl nitrate owing to availability and water solubility.

Synthesis of the hydrous zirconia may employ any of the usual methods known to those of skill in the art, including roasting, precipitation, or thermal decomposition. Base catalyzed precipitation of the hydrous zirconia is preferred because of problems with maintaining the proper acidity and water content when using other methods. The base used may be any of a number of commonly known and used base materials, or even the more exotic base materials although there is no particular advantage in the choice of exotic bases since the function of the base is to replace the zirconium counterion with hydroxide or oxide and to control the pH of the environment. Thus, lithium hydroxide, sodium hydroxide, potassium hydroxide, lithium carbonate, sodium carbonate, potassium carbonate, ammonium hydroxide, ammonium carbonate, or any organic amine containing 1 to 20 carbon atoms may be used as the base.

Typically, the zirconia salt precursor would be dissolved in water prior to treatment with the base. The concentration in the water solution is not critical with any amount from 0.01 to 95 weight percent or saturation being suitable, with concentrations of 1 to 50 weight percent and 10-20 weight percent in water being typical. After treating the zirconium salt solution with base to the proper pH (i.e., near neutrality at, for example about 5 to about 7), the crude hydrous zirconia is precipitated and recovered by filtration or centrifugation. The crude hydrous zirconia is washed thoroughly with, for example, water to remove as much of the original counter ion (i.e., the anion on the starting Zr salt) as possible, thereby avoiding contaminants that could modify the catalytic properties and/or performance. Thus, for example, at least 90 weight percent, preferably at least 99.9 weight percent, of the original counter-ion is removed by washing to produce an active catalyst.

The final treatment to prepare the hydrous zirconia is calcining. Calcination is carried out at a temperature in the range of about 200° C. to about 600° C. with about 250° C. to about 500° C. being more preferred, and about 300° C. to about 400° C. being most preferred. The calcination conditions determine the residual water content and the surface area of the catalyst, both of which affect the catalytic activity. The calcining time depends on the final properties desired, but ranges of 10 minutes to 100 hours are preferred with 0.5-10 hours more preferred, and 1-3 hours most preferred. The surface area of the hydrous zirconia is about 3 to about 300 M²/gram, more preferably about 30 to about 150 M²/gram, and most preferably about 40 to about 60 M²/gram.

The catalyst for use in the present invention comprises copper deposited on hydrous zirconia; the zirconia portion of which may be prepared as above or purchased from commercially available sources. The catalyst may made by depositing a metal, a metal complex, or a metal salt in a suitable solvent using incipient wetness, evaporation, thermal decomposition, or metal splattering. A preferred method, however, is co-precipitation of solutions of a copper precursor compound and a zirconium salt or precursor compound using a base, such as sodium hydroxide, with techniques (reagent concentrations, neutralizing bases, final pH's, and calcining times and temperatures) such as those described above for preparing the hydrous zirconia. Examples of copper precursor compounds include copper chlorides, bromides, iodides, fluorides, nitrates, sulfates, phosphates, carbonates, bicarbonates, or aliphatic or aromatic carboxylates containing up to 20 carbon atoms. Other metal precursor compounds which may be used include metal complexes with the foregoing counterions or zero valent and complexed with ammonia, aliphatic or aromatic amines containing up to 20 carbon atoms, aliphatic or aromatic phosphines containing up to 20 carbon atoms, aliphatic or aromatic arsines containing up to 20 carbon atoms.

The amount of copper on the hydrous zirconia employed in the process of the present invention can vary substantially depending on the mode of operation and other process variables. Normally the amount of copper will be in the range of about 0.001 to 75 element percent, more typically 1 to 25 element percent, based on the total Copper and Zirconia elements in the catalyst. The preferred catalyst comprises about 10 to 20 element percent copper on hydrous zirconia.

Prior to their use, the catalysts are reduced with hydrogen to convert any copper oxides into a lower oxidation state, preferably into a zero valent metal. Although not preferred, this pre-reduction treatment may be accomplished in conjunction with the operation of the hydrogenolysis process of the invention. This pre-reduction generally takes place at temperatures between 200° C. and the calcining temperature with 250° to 500° C. being more preferred and 300° to 400° C. most preferred

The amount of catalyst normally used will give HOMeTHF and/or FTHF: catalyst gram atoms per mole ratio of about 0.1:1 to 10,000:1. Lower reactant:catalyst ratios are typical for the autoclave/slurry modes and the higher ratios are typical for the fixed bed systems. The more preferred reactant:catalyst ratio for either case is 0.1:1 to 100:1 with 0.2:1 to 50:1 being most preferred.

The present invention may be carried out in the presence of water, although it is not required. The amount of water used may vary from about 1 to 99 parts by weight per part by weight of the HOMeTHF and/or FTHF reactant. More common amounts of water, although not necessarily preferred are 10 to 90 parts by weight per part by weight of the HOMeTHF and/or FTHF reactant with 20 to 80 parts water (same basis) being most common. In addition, while a secondary alcohol may affect the ratio of the products made by the present process, which is described herein, a secondary alcohol may also serve as a solvent. Secondary alcohols, suitable as solvents, are those described herein. As noted below, cyclohexanol and 2-propanol (isopropanol) are preferred when a secondary alcohol is employed.

We have also found that the product mixture that typically results from operating the present invention, MeGBL and MeTHF, may be manipulated by the presence of a secondary alcohol because the alcohol acts as a hydrogen source. For example, when the process is performed using FTHF in the presence of hydrogen and a secondary alcohol, the product mixture tends to favor formation of MeTHF over MeGBL. Conversely, when the process is performed using FTHF in the presence of hydrogen and the subject catalyst, and a secondary alcohol is not employed, the product mix tends to favor MeGBL over MeTHF.

Similarly, although both MeGBL and MeTHF result from the present process when HOMeTHF is used as a starting material, under an inert atmosphere, the product mixture tends to favor formation of MeGBL over MeTHF when a secondary alcohol is not employed. That is, when contacting HOMeTHF with the subject catalyst and a secondary alcohol, under inert atmosphere, the product mixture tends to contain less MeGBL, and more MeTHF, than when performing the process in the absence of a secondary alcohol.

Suitable secondary alcohols for use in the process of the present invention include 2-propanol, 2-butanol, 2-pentanol, 3-pentanol, 3-methyl-2-butanol, 2-hexanol, 3-hexanol, 3-methyl-2-pentanol, 2-methyl-3-pentanol, 1-phenyl-2-propanol, 1,3-diphenyl-2-propanol and cyclohexanol and their derivatives. The secondary alcohols preferably are secondary alkanols or cycloalkanols, i.e., saturated, aliphatic and cycloaliphatic alcohols, containing from 3 to about 20 carbon atoms. 2-Propanol (or isopropanol) and cyclohexanol are the most preferred secondary alcohols. Benzylic and allylic alcohols are not suitably because they tend to hydrogenolyze under the reaction conditions.

The process may be carried out under inert atmosphere, such as nitrogen, carbon dioxide, argon, neon gas, and the like. Hydrogen gas may also be used, especially, when starting with FTHF or co-production of additional MeTHF is desired. Under hydrogen atmosphere both the HOMeTHF and/or FTHF reactant and some MeGBL is converted to MeTHF, which is illustrated by examples below. However, in the absence of hydrogen, a higher rate of the feed conversion can be achieved and so the the production rate to alpha-MeGBL and beta-MeGBL is higher.

The process may be carried out at temperatures in the range of about 250° to 500° C., preferably about 280° to 400° C., and most preferably about 300° C. to 320° C. The process is carried out using pressures of about 1 to 690 bars absolute (about 15 to about 10,012 pounds per square inch gauge—psig), preferably about 10 to 60 bars absolute, more preferably about 15 to about 55 bars, and most preferably 40 to 55 bars absolute.

The reaction time required to give satisfactory results will vary significantly depending upon a number of process variables such as process temperature and pressure, type of atmosphere, and the particular catalyst employed, and which product is more desired. The time range normally is from about 10 sec to 10 min residence time with 10 sec to 90 sec being more typical.

As stated herein, the product resulting from operating the present invention typically contains a mixture of alpha-MeGBL and beta-MeGBL and MeTHF. The resulting product may be easily separated by techniques known to those of skill in the art. For example, since alpha-MeGBL and MeTHF have quite different boiling points (200-201° Celsius and 86° Celsius, respectively), they may easily be separated by distillation.

The ratio of alpha-Me to beta-Me isomer of MeGBL formed in carrying out the process of the invention, is normally in the range of 4.0:1-5.5:1 depending on, e.g., the conversion and the residence time. We have found that the higher the conversion and the residence time, the more beta-MeGBL isomer formed.

### EXAMPLES

The processes provided by the present invention are further illustrated by the following examples. All percentages given in the examples are by weight unless specified otherwise. As used herein, the percent conversion of HOMeTHF (or FTHF) is:

$$\frac{Moles HOMeTHF ( or FTHF ) Converted to All Products}{Moles HOMeTHF ( or FTHF ) Fed} \times 100$$

percent selectivity to a compound is:

$$\frac{Moles HOMeTHF ( or FTHF ) Converted to a Compound}{Moles HOMeTHF ( or FTHF ) Converted to All Products} \times 100$$

and percent yield of a compound is:

$$\frac{Moles HOMeTHF ( or FTHF ) Converted to a Compound}{Moles HOMeTHF ( or FTHF ) Fed} \times 100$$

Catalyst Preparation

Preparation of Copper on Zirconia Support Catalyst

Zirconium sulfate tetrahydrate (106.5 g, 0.3 mol) and copper chloride hydrate (4.0 g, 0.03 mol) were dissolved in 1000 ml of water. Aqueous KOH solution (50%) was added dropwise with occasionally stirring until reaching a pH of 9-10. The light blue precipitate was left in the original solution and thus aged for 48 hours. The precipitate was washed with deionized water until no sulfate ion detected with barium chloride and no chloride ion detected with silver nitrate. The resulting solid was dried at room temperature for 5 hours, and at 110° C. for 5 hours. It was then calcined at 400° C. for 10 hours. The resulting copper on hydrous zirconia catalyst was reduced under hydrogen for 3 hours at 300° C. The calculated copper content was 10 molar percent.

### Example 1

Reaction of FTHF with Copper-on-Hydrous Zirconia Catalyst Under Hydrogen Atmosphere in a Batch Run.

A 300 ml autoclave was charged with FTHF (10.0 g, 0.1 mol), water (10.0 g, 0.55 mol), and a catalyst (10.0 g) comprising 10% copper on hydrous zirconia. The autoclave was flushed with hydrogen three times at 3.4 barg (50 psig) pressure. The initial hydrogen pressure was set at 13.8 barg (200 psig). The autoclave was stirred and heated for 2 hours at 150° C. and for an additional 2 hours at 280° C. A sample was taken from autoclave and analyzed by GC which showed that the reaction mixture comprised 49.6% alpha-MeGBL and beta-MeGBL, 42.8% HOMeTHF and 5.3% MeTHF. Stirring and heating of the reaction mixture was continued for an additional 2 hours at 300° C. and 44.8 barg (650 psig) hydrogen pressure. The autoclave was cooled down to ambient temperature and the gas was vented off. The crude mixture was analyzed by GC. The conversion of FTHF was complete. The selectivities to MeGBL and co-products were: mixture of alpha-Me and beta-Me GBL −64.4%; MeTHF −14.3%; and HOMeTHF 21.4%.

### Example 2

Reaction of FTHF with Copper-on-Hydrous Zirconia Catalyst Under Hydrogen Atmosphere in a Batch Run.

This was done similar to Example 1, except that the autoclave was stirred and heated for 2 hours at 150° C. and for additional 8 hours at 300° C. The crude mixture was analyzed by GC. The conversion of FTHF was complete. The selectivities to MeGBL and co-products were: alpha-MeGBL −76.6%; beta-MeGBL −13.7%; MeTHF −3.9%; and HOMeTHF 2.1%.

### Example 3

Dehydrogenation of HOMeTHF with Copper-on-Hydrous Zirconia Catalyst Under Nitrogen in a Continuous Run.

A mixture of water 56%, HOMeTHF 43% feed was fed into a one inch tubular reactor filled with Cu/ZrO2 catalyst (130 ml catalytic bed) at 37.9 ml/hr rate at 250-370° C. and 54.4 bar (800 psi) nitrogen pressure. The product was collected after each 3 hrs run and analyzed by GC. The selectivity and production rates are shown in Table 1.

TABLE 1

| Variables | | | | | | | | Production, | |
|---|---|---|---|---|---|---|---|---|---|
| | | Gas | feed | Yield, % | | | Conver- | g*L⁻¹*hr⁻¹ | |
| Temp. | Temp. | Flow | rate | 3-Me- | 4-Me- | 3-Me- | sion | Me- | Me- |
| Mid. | Bottom | Ml/min | ml/hr | GBL | GBL | THF | % | THF | GBL |
| 290 | 346 | 141.6 | 38.1 | 56.9 | 14.2 | 9.3 | 4.23 | 9.6 | 91.3 |
| 290 | 346 | 141.6 | 39.2 | 54.0 | 13.1 | 11.3 | 5.88 | 11.2 | 81.7 |
| 275 | 335 | 141.6 | 38.4 | 53.1 | 11.3 | 12.0 | 11.21 | 12.8 | 81.7 |
| 275 | 335 | 70.8 | 39.0 | 54.5 | 11.7 | 12.0 | 12.17 | 12.8 | 76.9 |
| 285 | 340 | 283.2 | 39.2 | 51.8 | 11.2 | 10.7 | 10.68 | 11.2 | 80.1 |
| 285 | 340 | 471.9 | 39.0 | 52.7 | 11.5 | 8.4 | 12.43 | 8.0 | 76.9 |
| 285 | 360 | 471.9 | 54.0 | 49.4 | 11.0 | 7.2 | 14.06 | 11.2 | 108.9 |
| 250 | 340 | 943.9 | 90.0 | 24.7 | 4.5 | 1.8 | 40.99 | 4.8 | 78.5 |
| 260 | 370 | 943.9 | 90.0 | 25.3 | 4.7 | 2.1 | 47.99 | 4.8 | 92.9 |

### Example 4

Reaction of HOMeTHF with Copper-on-Hydrous Zirconia Catalyst Under Hydrogen in a Continuous Run.

A mixture of water (55%), HOMeTHF (43.8%) was fed into a one inch tubular reactor filled with Cu/ZrO₂ catalyst (130 ml catalytic bed) at 35.0-39.4 ml/hr rate at 260-340° C. and 54.4 barg (800 psig) hydrogen pressure. The product was collected every 3 hrs and analyzed by GC. The selectivity and production rates are shown in the Table 2.

TABLE 2

| Variables | | | | | | | | Production, | |
|---|---|---|---|---|---|---|---|---|---|
| | | Gas | feed | Yield, % | | | Conver- | g*L⁻¹*hr⁻¹ | |
| Temp. | Temp. | Flow | rate | 3-Me- | 4-Me- | 3-Me- | sion | Me- | Me- |
| Mid. | Bottom | ml/min | ml/hr | GBL | GBL | THF | % | THF | GBL |
| 260 | 310 | 1416 | 35.0 | 11.0 | 4.9 | 10.7 | 54.6 | 11.2 | 17.6 |
| 280 | 310 | 471.9 | 37.2 | 8.8 | 3.6 | 13.0 | 35.9 | 14.4 | 16.0 |
| 313 | 320 | 235.9 | 38.8 | 17.8 | 7.2 | 33.5 | 67.7 | 38.4 | 33.6 |
| 340 | 340 | 141.6 | 39.4 | 26.1 | 10.4 | 40.4 | 84.4 | 46.4 | 49.6 |

### Example 5

Reduction of FTHF with Hydrogen, Continuous Run—Copper/Zirconia Catalyst with Secondary Alcohol

A mixture of isopropanol (38.73%), water (36.74%), and FTHF (23.81%) was fed into a one inch tubular reactor filled with Cu/ZrO2 catalyst (130 ml catalytic bed) at 37.3-39.4 ml/hr rate at 300-344° C. and 800 psi hydrogen pressure. The product was collected every 3 hrs and analyzed by GC. The yield and production rates at full conversion are shown in the Table 3.

TABLE 3

| Variables | | | | | | | | | |
|---|---|---|---|---|---|---|---|---|---|
| | | Gas | feed | Yield % | | | | Production | |
| Temp. | Temp. | Flow | rate | 3-Me- | 4-Me- | 3-Me- | HOMe- | Me-THF, | Me-GBL, |
| Mid. | Bottom | ml/min | ml/hr | GBL | GBL | THF | THF | g/L-hr | g/L-hr |
| 315 | 300 | 236 | 39.4 | 21.5 | 10.2 | 52.5 | 7.00 | 33.6 | 24.0 |
| 335 | 320 | 236 | 39.1 | 16.7 | 8.2 | 60.0 | 1.62 | 33.6 | 16.0 |
| 344 | 330 | 378 | 37.3 | 6.9 | 3.4 | 67.8 | 0.00 | 36.8 | 6.4 |

### Example 6

Reduction of FTHF with Hydrogen, Continuous Run, Repetition of Example 5—Copper/Zirconia Catalyst and Secondary Alcohol

A mixture of isopropanol (21.91%), water (44.81%), FTHF (30.86%) was fed into a one inch tubular reactor filled with Cu/ZrO2 catalyst (130 ml catalytic bed) at 37.7-38.8 ml/hr rate at 310-348° C. and 800 psi hydrogen pressure. The product was collected every 3 hrs and analyzed by GC. The selectivity and production rates are shown in the Table 4.

TABLE 4

| Variables | | | | Yield | | | | | |
|---|---|---|---|---|---|---|---|---|---|
| | | Gas | feed | | | 3- | | Production | |
| Temp. | Temp. | Flow | rate | 3-Me- | 4-Me- | Me- | HOMe- | Me-THF, | Me-GBL, |
| Mid. | Bottom | ml/min | ml/hr | GBL | GBL | THF | THF | g/L-hr | g/L-hr |
| 348 | 330 | 378 | 38.4 | 8.1 | 4.0 | 55.8 | 0.00 | 43.2 | 11.2 |
| 335 | 320 | 472 | 38.8 | 19.5 | 8.5 | 65.5 | 0.00 | 59.3 | 28.8 |
| 320 | 310 | 944 | 37.7 | 19.8 | 7.6 | 65.7 | 4.23 | 52.9 | 25.6 |

### Example 7

Reduction of FTHF with Hydrogen, Continuous Run, Repetition of Example 5—Copper/Zirconia Catalyst and Secondary Alcohol

A mixture of isopropanol (10.91%), water (50.88%), FTHF (35.2%) was fed into a one inch tubular reactor filled with Cu/ZrO2 catalyst (130 ml catalytic bed) at 39.4 ml/hr rate at 310-320° C. and 800 psi hydrogen pressure. The product was collected after 3 hrs run and analyzed by GC. The selectivity and production rates are shown in the Table 5.

TABLE 5

| Variables | | | | Yield, % | | | | | |
|---|---|---|---|---|---|---|---|---|---|
| | | Gas | feed | 3- | | | | Production | |
| Temp. | Temp. | Flow | rate | Me- | 4-Me- | 3-Me- | HOMe- | Me-THF, | Me-GBL, |
| Mid. | Bottom | ml/min | ml/hr | GBL | GBL | THF | THF | g/L-hr | g/L-hr |
| 320 | 310 | 944 | 39.4 | 19.5 | 7.4 | 57.8 | 7.62 | 60.9 | 33.6 |

### Example 8

Reduction of HOMe-THF, Continuous Run—Copper/Zirconia Catalyst with Secondary Alcohol

A mixture of isopropanol 40.52%, water 33.98%, HOMeTHF 25.49% was fed into a one inch tubular reactor filled with Cu/ZrO2 catalyst (130 ml catalytic bed) at 37.6-37.9 ml/hr rate at 284-340° C. and 800 psi nitrogen pressure. The product was collected every 3 hrs and analyzed by GC. The selectivity and production rates are shown in the Table 6.

TABLE 6

| Variables | | | | Yield, % | | | | | |
|---|---|---|---|---|---|---|---|---|---|
| | | Gas | feed | | | 3- | HOMe-THF | Production | |
| Temp. | Temp | Flow | rate | 3-Me- | 4-Me- | Me- | conversion, | Me-THF, | Me-GBL, |
| Mid. | Bottom | ml/min | ml/hr | GBL | GBL | THF | % | g/L-hr | g/L-hr |
| 284 | 300 | 47 | 37.9 | 21.8 | 8.3 | 23.5 | 67.0 | 14.4 | 20.8 |
| 340 | 340 | 47 | 37.6 | 33.9 | 12.7 | 30.6 | 89.0 | 19.2 | 33.6 |

### Example 9

Reduction of FTHF, Continuous Run—Copper/Zirconia Catalyst and Secondary Alcohol

A mixture of isopropanol (38.73%), water 36.74%, FTHF (23.81%) was fed into a one inch tubular reactor filled with Cu/ZrO2 catalyst (130 ml catalytic bed) at 37.9 ml/hr rate at 340° C. and 800 psi nitrogen pressure. The product was collected after 3 hrs and analyzed by GC. The selectivity and production rates are shown in the Table 7.

TABLE 7

| Variables | | | | Yield | | | | | |
|---|---|---|---|---|---|---|---|---|---|
| | | Gas | feed | 3- | | 3- | | Production | |
| Temp. | Temp. | Flow | rate | Me- | 4-Me- | Me- | HOMe- | Me-THF, | Me-GBL, |
| Mid. | Bottom | SCF/hr | ml/hr | GBL | GBL | THF | THF | g/L-hr | g/L-hr |
| 340 | 340 | 47 | 37.9 | 25.0 | 8.9 | 27.5 | 0.00 | 14.4 | 22.4 |

The invention has been described in detail with particular reference to preferred embodiments thereof, but it will be understood that variations and modifications can be effected within the spirit and scope of the invention.

We claim:

1. Process for preparing a mixture of alpha- and beta-methyl-gamma-butyrolactones (MeGBL) and 3-methyltetrahydrofuran (MeTHF), which comprises contacting 3-formyltetrahydrofuran (FTHF) or 3-hydroxymethyltetrahydrofuran (HOMeTHF), or a mixture thereof, with hydrogen in a reaction zone in the presence of a catalyst comprising copper on hydrous zirconia under conditions of temperature and pressure conducive to the formation of MeGBL and MeTHF.

2. Process according to claim 1 wherein the process is carried out at a temperature of about 250° to about 320° C. and a pressure of about 15 to about 55 bars.

3. Process according to claim 1 wherein contacting is carried out in the presence of a secondary alcohol.

4. Process according to claim 3 wherein the secondary alcohol is cyclohexanol or 2-propanol.

5. Process according to claim 4 wherein the process is carried out at a temperature of about 250° to about 320° C. and a pressure of about 15 to about 55 bars.

6. Process for preparing a mixture of alpha- and beta-MeGBL and MeTHF, which comprises contacting FTHF or HOMeTHF, or a mixture thereof, with a catalyst comprising copper on hydrous zirconia and, optionally, a secondary alcohol, in a reaction zone under an inert atmosphere and under conditions of temperature and pressure conducive to the formation of MeGBL and MeTHF.

7. Process according to claim 6 wherein the inert atmosphere is nitrogen or carbon dioxide.

8. Process according to claim 7 wherein the process is carried out at a temperature of about 250° to about 320° C. and a pressure of about 15 to about 55 bars.

9. Process according to claim 8 wherein the contacting is carried out in the presence of hydrogen.

10. Process according to claim 7 or 9 wherein the secondary alcohol is cyclohexanol or 2-propanol.

11. Process for preparing a mixture of alpha- and beta-MeGBL, which comprises contacting FTHF with hydrogen in a reaction zone in the presence of a catalyst comprising copper on hydrous zirconia under conditions of temperature and pressure conducive to the formation of MeGBL.

12. Process according to claim 11 wherein the process is carried out at a temperature of about 2500 to about 320° C. and a pressure of about 15 to about 55 bars.

13. Process for preparing MeTHF, which comprises contacting FTHF with hydrogen and a secondary alcohol in a reaction zone in the presence of a catalyst comprising copper on hydrous zirconia under conditions of temperature and pressure conducive to the formation of MeTHF.

14. Process according to claim 13 wherein the process is carried out at a temperature of about 2500 to about 320° C. and a pressure of about 15 to about 55 bars.

15. Process according to claim 13 wherein the secondary alcohol is cyclohexanol or 2-propanol.

16. Process for preparing a mixture of alpha- and beta-MeGBL, which comprises contacting HOMeTHF with a catalyst comprising copper on hydrous zirconia in a reaction zone under an inert atmosphere and under conditions of temperature and pressure conducive to the formation of MeGBL.

17. Process according to claim 16 wherein the process is carried out at a temperature of about 2500 to about 320° C. and a pressure of about 15 to about 55 bars.

18. Process according to claim 16 wherein the inert atmosphere is nitrogen or carbon dioxide.

19. Process for preparing MeTHF, which comprises contacting HOMeTHF with a secondary alcohol in a reaction zone under an inert atmosphere in the presence of a catalyst comprising copper on hydrous zirconia under conditions of temperature and pressure conducive to the formation of MeTHF.

20. Process according to claim 19 wherein the process is carried out at a temperature of about 2500 to about 320° C. and a pressure of about 15 to about 55 bars.

21. Process according to claim 19 wherein the secondary alcohol is cyclohexanol or 2-propanol.

22. Process according to claim 21 wherein the inert atmosphere is nitrogen or carbon dioxide.
